(19) United States
(12) Patent Application Publication
(10) Pub. No.: US 2015/0282896 A1
(43) Pub. Date: Oct. 8, 2015

(54) DENTAL TOOL

(71) Applicant: Aproxi ApS, Herlev (DK)

(72) Inventors: Jens Ulsø, Baekke (DK); Per Bækgaard, Hoersholm (DK)

(21) Appl. No.: 14/436,043

(22) PCT Filed: Oct. 16, 2012
(86) PCT No.: PCT/EP2012/070467

§ 371 Date: Apr. 15, 2015

(51) Int. Cl. A61C 5/12

(52) U.S. Cl. CPC A61C 5/12

(57) ABSTRACT

The invention provides a dental tool for insertion between two adjacent teeth to provide a-traumatic separation of adjacent teeth of a human being. The tool comprises a base, a first leg for placement in a first gum pocket and for abutting a first one of the two adjacent teeth and a second leg for placement in a second gum pocket and for abutting a second one of the two adjacent teeth. The first and second legs are elongated and extend from the base in an oblong direction towards an end. The legs are separated with an interspace between them for accommodating gum tissue. The invention further provides a method for providing a-traumatic separation of two adjacent teeth of a human being during dental restoration.

### FIELD OF THE INVENTION

The present invention relates to a dental tool for use in dental restoration, especially a tool for providing a-traumatic separation of two adjacent teeth during dental restoration. Furthermore, the present invention relates to a method for providing a-traumatic separation of two adjacent teeth during dental restoration.

### BACKGROUND OF THE INVENTION

When a decayed portion of a tooth is located near its interproximal area, usually, the tooth structure itself is insufficient to provide support for the filling material during the restoration process, where filling material is filled into the excavated cavity. During hardening of the filling material, a matrix band is positioned around the excavated part of the tooth and pressed against the tooth surface near the cavity, thereby forming an outer shell.

Normally, adjacent teeth are forced a certain distance apart during the restoration process so that the filling material when hardened and after reorientation of the teeth provides adequate contact between the restored tooth and the neighbouring tooth. Often, a dental wedge formed from wood or plastic is used for separating the teeth and for holding the matrix band in place. The wedge is forced into the interproximal space between the adjacent teeth at the gum line for causing the teeth to separate and for sealing the matrix band against the tooth to retain the filling material in the cavity.

The fact that most dental wedges are constructed for optimal positioning above the gum line, that means distant from the gums, does not harmonize with the fact that most interproximal cavities extend to positions under the gum line. In order for the matrix band to be retained against the cavity also below the gum line, wedges are forced deeply into the space between the adjacent teeth, positioning the wedge deeply in the gum tissue. However, the latter causes bleeding, which is undesirable during the restoration process, and is uncomfortable for the patient. In addition, it may cause trauma to the gum tissue to a degree which does not guarantee complete recovery of the gum tissue. Thus, prior art dental wedges have a number of disadvantages.

Though the separation of the teeth may be performed with other tools, the task for holding the matrix band itself, still, requires certain tools, such as wedges, pressing the matrix band against the tooth. Thus, it would be desirable to reduce the risk for gum trauma while keeping the versatility that wedges provide.

Special shapes of such wedges have been developed to improve the art, for example in U.S. Pat. No. 3,890,714 by Gores, disclosing a hollow wedge in cross-sectional V-shape, US patent No. 7,083,412 by Karapetyan, disclosing various formed wedges, US patent application NO. 2008/187881 by Rus, disclosing a V-shaped wedge, International patent application WO99/09907 by Garrison, disclosing a wedge with a triangular cross section, German Utility model DE9217796U1 by Buddenberg, disclosing a triangular wedge.

### DESCRIPTION OF THE INVENTION

It is an object of embodiments of the invention to provide an improved dental tool, and particularly to provide a dental tool for insertion between two adjacent teeth, e.g. during restoration.

It is a further object of embodiments of the invention to provide a dental tool for a-traumatic separation of the adjacent teeth which thereby minimizes the risk for gum trauma and decreases the risk for bleeding caused by insertion of the dental tool between two adjacent teeth.

It is an even further object of embodiments of the invention to provide a dental tool for holding a matrix band against a tooth when a tooth cavity is filled with restoration material.

It is an even further object of embodiments of the invention to provide a method for providing a-traumatic separation of two adjacent teeth during dental restoration.

According to a first aspect, the invention provides a dental tool for insertion between two adjacent teeth to provide a-traumatic separation of adjacent teeth of a human being, the tool comprising a base, a first leg for placement in a first gum pocket and for abutting a first one of the two adjacent teeth and a second leg for placement in a second gum pocket and for abutting a second one of the two adjacent teeth, the first and second legs being elongated and extending from the base in an oblong direction towards an end, the legs being separated with an interspace between them for accommodating gum tissue.

When inserting the dental tool between two adjacent teeth so that at least a part of the legs is abutting the first and second tooth respectively, while at the same time placing the legs in gum pockets, the dental tool may a-traumatically separate the teeth, i.e. separate the teeth without providing trauma. Furthermore, the tool may support a matrix band positioned around the excavated part of the tooth to be restored.

The length of the legs in the oblong direction may be longer than the size of the teeth so that a part of the legs extends one at least one of the sides of the teeth. This may be inside the mouth and/or on the outer side of the teeth. The length of the legs may thus be in the range of 5-10 mm, such as 6-9 mm.

The legs may have a thickness so that the legs fit into the gum pockets with only minimal risk of causing gum trauma. The thickness may be in the range of 0.1-1 mm, such as in the range of 0.3-0.5 mm. When inserting the dental tool between two adjacent teeth, the tool is positioned so that the first leg is placed in a gum pocket between the gum tissue and the first tooth and the second leg is placed in a gum pocket between the gum tissue and the second tooth. The width between the legs may thus be suitable for accommodating gum tissue.

To facilitate support of teeth and/or a matrix band, the height of the legs may be in the range of 1-2.5 mm, such as in the range of 1.3-2.3 mm. To reduce the risk of damaging tissue during insertion of the dental tool, the height of the legs may be smaller closer to the end, than the height closer at the base. To reduce the risk even further, the legs may comprise a front section in with the height tapers down towards to end. Furthermore, the lower edge of the legs may comprise rounded edges.

The base connects the legs to each other, and may further be used to position the tool correctly between the two adjacent teeth. It may be an advantage if the tool is small, thereby minimizing the discomfort experienced by the human being having a tooth restored. Thus, the legs may be longer than the base in the oblong direction. The length of the base in the oblong direction may be in the range of 1-5 mm, such as in the range of 2-3 mm.

To provide the required strength of the tool, it may be made from different materials, such as metal, fibre reinforced polymer, or wood. If made of metal, steel may be preferred. In order to prevent slippage of the dental tool when inserted into the gum pockets, at least the side of the legs facing the teeth may be covered by a high friction material.

The tool may be made in one piece. As an alternative, the tool may be made from different elements, whereby the tool may be adapted to be separated in at least two separate elements.

In one embodiment, the end may be a free end with no contact between the legs.

In an alternative embodiment the dental tool may comprise an end portion joining the first and second legs. The end portion may form part of the tool, or may be a separate element. In a further alternative the end portion and one of the legs may be formed in one piece, and the base and the other one of the two legs may be formed in one piece, whereby providing a dental tool comprising two L-shaped elements.

The first and second legs may extend substantially symmetrically around a centre plane positioned centrally between the legs and extending in the oblong direction.

To facilitate pressing the teeth apart and/or facilitate holding of a matrix band tightly against a tooth, the first and second legs may be elastically deformable to enable deformation hereof in a direction transverse to the oblong direction thereby providing a spring force when deformed during insertion between two adjacent teeth. When the tool is inserted between two adjacent teeth, the legs may be pressed together by the fingers of the dentist, or by a suitable tool. When released between the teeth, the spring force is towards the teeth. The size of the spring force depends on the depth of insertion of the dental tool between the teeth, as it depends on the distance to the base.

The spring force may be dependent on different aspects, such as the material from which the tool is made, the width of the interspace, i.e. the distance between the legs, etc. Thus, the spring force may be chosen to be strong enough to press the teeth apart. Alternatively, other tools may press the teeth apart, and the spring force may be chosen so that it can press a matrix band against the surface of the tooth which has to be restored.

When the dental tool is removed after completion of restoration, the teeth are released from the spring force thereby relocating with very narrow space between the teeth.

To enhance the ability of pressing the teeth apart, the first and second legs may be mutually inclined, i.e. the legs may each form an angle different form 90 degrees from the centre plane. As the legs extend from the base, the base may consequently be V-shaped, thereby forming a dental tool of substantially triangular shape. The angle between the legs may be in the range of 20-60 degrees, such as in the range of 30-45 degrees. By inclining the first and second legs relative to each other, gum tissue may extend between the legs within the interspace without causing trauma to the gum tissue, or at least considerably minimizing the risk of trauma.

The height of the dental tool may be in the range of 0.7-1.6 mm, such as 1-1.3 mm, dependent on the inclination of the legs relative to the centre plane.

In one embodiment, the first leg and the second legs extend substantially parallel.

In an alternative embodiment of the dental tool, the first and second legs comprise a first section where the legs diverge, and a second section where the legs converge, the first section being positioned adjacent to the base. Thus, the legs may extend away from each other at the first section being located closest to the base, and may extend towards each other at the second section being further away from the base, whereby the distance between the legs change along the length of legs. In the transition between the first and second section, the size of the interspace is the greatest. By lowering the distance between the legs at the second section, insertion of the dental tool may be facilitated. Furthermore, the increased distance between the legs at the first section may increase the spring force provided during insertion.

To minimise risk of trauma or smaller injuries due to sharp edges, at least one of the first and second sections may be arc shaped. The length of the first and second sections may be of substantially the same size, such as in the range of 4-6 mm each.

The first and second legs may comprise a third section where the legs diverge, the third section being positioned opposite to the base. The third section may also be arc shaped. Alternatively, the legs may comprise a third section where the legs are substantially parallel. The length of the third section may be smaller, than the length of the first and second sections, such as in the range of 1-3 mm.

In a further alternative, the legs may be substantially straight extending towards each other towards the end so that the size of interspace decreases towards the end. This may facilitate positioning of the dental tool, while at the same time increasing the ability of providing a spring force.

When the dental tool is inserted into gum pockets, damage to the tissue may result in bleeding. This blood, as well as tissue liquid, has to be kept away from the gum tissue during restoration of the tooth. Consequently, a thread is typically arranged in the space between the teeth and the gum tissue for absorbing the liquid in the thread material. In order to provide space for such threads, the legs may be provided with a tapering side-section. This may be achieved by providing the legs with a thickness which in a cross-section perpendicular to the oblong direction is non-uniform. The thickness may in the cross-section thus be lower at an upper part of the legs. The tapering section may be of a length of approximately ¼ of the height of the legs. The tapering section may be provided at the side of the legs pointing away from the interspace, where the gum tissue is accommodated. The tapering may thereby provide an indentation for a dental thread.

It should be understood that the upper part of the legs is when the dental tool is positioned in the lower part of the mouth. In the upper part of the mouth, it would be the lower part of the legs, i.e. the reverse.

The base may comprise a support plate adapted to be bended along an edge of the base to form a triangular shaped base, i.e. a base forming a substantially closed triangular shape in a cross-section perpendicular to the oblong direction. The support plate may extend in a direction perpendicular to the centre plane along an edge of the base extending along one of the first and second legs. When the support plate is bended along this edge, the V-shaped base and the support plate may form a substantially triangular shaped element. This may increase stability of the base, thereby facilitating positioning of the dental tool.

To further facilitate positioning and/or removal of the dental tool, the base may comprise at least one handling opening adapted to receive a handling tool to facilitate positioning and/or removal of the dental tool between/from two adjacent teeth. The handling tool may as an example be a traditional dental instrument, such as tweezers.

In one embodiment, the at least one handling opening is a through hole, through which a part of the handling tool may be inserted.

To ensure that the dental tool is kept in place during the restoration process, the dental tool may further comprise a locking member adapted to lock the first and second legs relative to each other to ensure a predetermined distance between the legs. The locking member may comprise a first cavity to receive the first leg and a second cavity to receive the second leg.

The cavities may be through holes, through which the legs can be inserted after positioning of the dental tool. In an alternative embodiment, the cavities may be indentations, each having an opening in each of the sides of the locking member, through which openings the leg can be inserted. When the legs are positioned in the locking member, they are locked relative to each other thereby ensuring a predetermined distance between them.

To increase the spring force exerted by the legs, the distance between the first and second cavities may be larger than the distance between the first and second legs, whereby the legs may be pressed away from each other to increase the force.

As the resulting spring force exerted by the legs may not be perpendicular to the centre line, since the spring force decreases with the distance to the base, the locking member may further compensate this oblique angle by adding a force towards the teeth further away from the base.

To keep the locking member in place, at least a part of the cavities may be covered by a high friction material.

To minimize the number of items to be positioned in the mouth of the human being, the dental tool may further comprise a separation member adapted to separate the upper part of two adjacent teeth (the part being furthest away from the gum tissue). The separation member may be attached to one of the first and second legs and may extend substantially along the centre plane. The separation member may further replace the matrix band, thereby reducing the workload for the dentist, as he has fewer tools to arrange.

According to a second aspect, the invention provides a method for providing a-traumatic separation of two adjacent teeth of a human being during dental restoration, the method comprising the steps of:

providing a dental tool according to the first aspect of the invention;

inserting the first leg in a first gum pocket so that it abuts a first one of two adjacent teeth; and

inserting the second leg in a second gum pocket so that it abuts a second one of two adjacent teeth, such that gum tissue becomes located in the interspace between the legs.

It should be understood, that a skilled person would readily recognize that any feature described in combination with the first aspect of the invention could also be combined with the second aspect of the invention, and vice versa.

The dental tool according to the first aspect of the invention is very suitable for performing the method steps according to the second aspect of the invention. The remarks set forth above in relation to the dental tool are therefore equally applicable in relation to the method for providing dental restoration.

### BRIEF DESCRIPTION OF THE DRAWINGS

Embodiments of the invention will now be further described with reference to the drawings, in which:

FIG. 1 illustrates an embodiment of a dental tool seen from above;

FIG. 2 illustrates a cross-sectional view through an embodiment of a dental tool;

FIGS. 3a and 3b illustrate a alternative embodiment of a dental tool seen form above and a side-view hereof;

FIG. 4 illustrates an alternative embodiment of a dental tool;

FIGS. 5a and 5b illustrate a 3D view of two different embodiments of a dental tool;

FIG. 6 illustrates an embodiment of a dental tool inserted between two adjacent teeth;

FIGS. 7-9 illustrate three different embodiments of a dental tool seen from above;

FIG. 10 illustrates a 3D view of an embodiment of a dental tool;

FIG. 11 illustrates a side-view of a dental tool inserted between two adjacent teeth;

FIG. 12 illustrates a top-view of a dental tool inserted between two adjacent teeth;

FIGS. 13a and 13b illustrates two different embodiments of a locking member;

FIGS. 14 and 15 illustrate the use of a locking member;

FIG. 16 illustrates a dental tool inserted between two adjacent teeth together with a matrix band;

FIG. 17 illustrates a dental tool inserted between two adjacent teeth together with a matrix band and a dental thread;

FIG. 18 illustrates an embodiment of a dental tool inserted between two adjacent teeth, the tool comprising a separation member; and

FIG. 19 illustrates a side-view of the dental tool illustrated in FIG. 18.

### DETAILED DESCRIPTION OF THE DRAWINGS

It should be understood that the detailed description and specific examples, while indicating embodiments of the invention, are given by way of illustration only, since various changes and modifications within the spirit and scope of the invention will become apparent to those skilled in the art from this detailed description.

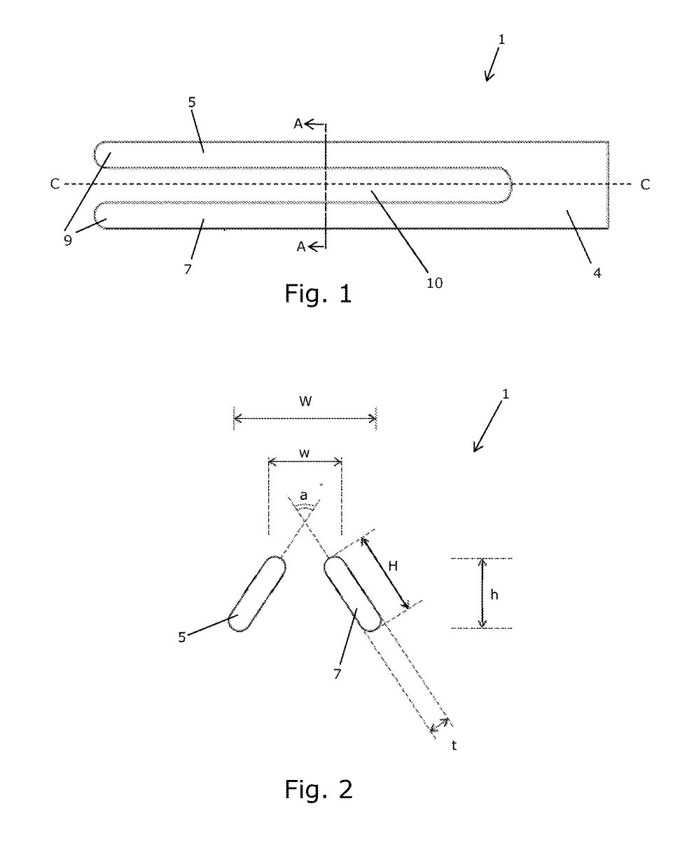

FIG. 1 illustrates an embodiment of a dental tool 1 seen from above. The dental tool 1 is for insertion between two adjacent teeth 2, 3 (see FIG. 6) of a human being to provide a-traumatic separation hereof. The dental tool 1 comprises a base 4, a first leg 5 for placement in a first gum pocket 6 (see FIG. 6) and for abutting a first one 2 of the two adjacent teeth and a second leg 7 for placement in a second gum pocket 8 (see FIG. 6) and for abutting a second one 3 of the two adjacent teeth. The first and second legs 5, 7 are elongated and extend from the base 4 in an oblong direction towards an end 9. The legs 5, 7 are separated with an interspace 10 between them for accommodating gum tissue 11 (see FIG. 6).

As the dental tool 1 can be oriented so that it both fits between adjacent teeth in the upper part of the mouth and in the lower part of the mount, the use of the phrase “seen from above” is for illustration only, as the tool may be turned upside down.

The first and second legs 5, 7 extend substantially symmetrically around a centre plane positioned centrally between the legs and extending in the oblong direction. The dotted line CC illustrates the centre plane. In the illustrated embodiment, the legs 5, 7 extend substantially parallel. The length of the legs 5, 7 may be in the range of 5-10 mm, such as 6-9 mm.

To facilitate pressing the teeth 2, 3 apart and/or facilitate holding of a matrix band tightly against a tooth, the first and second legs 5, 7 are elastically deformable to enable deformation hereof in a direction transverse to the oblong direction thereby providing a spring force when deformed during insertion between two adjacent teeth. When the tool is inserted between two adjacent teeth, the legs 5, 7 can be pressed together by the fingers of the dentist, or by a suitable tool. When released between the teeth, the spring force is towards the teeth. The size of the spring force depends on the depth of insertion of the dental tool between the teeth, as it depends on the distance to the base 4.

When the dental tool is removed after completion of restoration, the teeth are released from the spring force thereby relocating with very narrow space between the teeth.

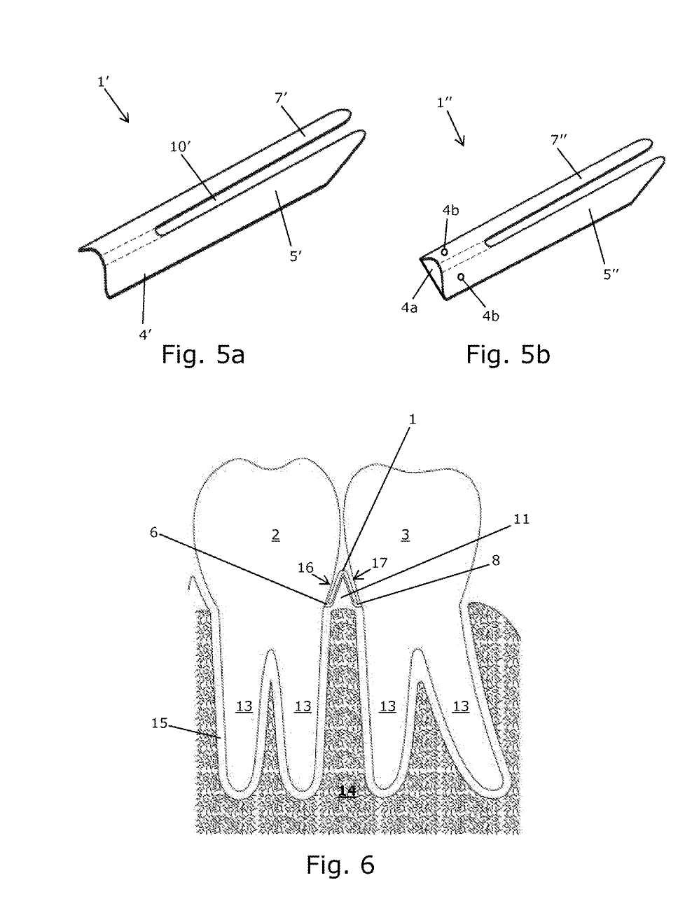

FIG. 2 illustrates a cross-sectional view at line AA through the dental tool 1 of FIG. 1. The first and second legs 5, 7 are mutually inclined so that the legs 5, 7 each form an angle from the centre plane CC in order to fit into the gum pockets 6, 8 (see FIG. 6). As the legs 5, 7 extend from the base 4, the base 4 is consequently V-shaped (see FIG. 5), thereby forming a dental tool 1 of substantially triangular shape. The angle between the legs 5, 7 is illustrated by a, and may be in the range of 20-60 degrees, such as in the range of 30-45 degrees.

The width W of the dental tool 1 is adapted to fit into the gum pockets 6, 8 (see FIG. 6) with minimal damage and strain to the gum tissue 11 on the one hand, and sufficient stability to exert sufficient force to the teeth on the other hand.

The height h of the dental tool may be in the range of 0.7-1.6 mm, such as 1-1.3 mm, dependent on the inclination of the legs 5, 7 relative to the centre plane CC.

The legs 5, 7 have a thickness so that the legs fit into the gum pockets 6, 8 (see FIG. 6) with only minimal risk of causing gum trauma. The thickness t may be in the range of 0.1-1 mm, such as in the range of 0.3-0.5 mm. The width w between the legs is suitable for accommodating gum tissue 11 (see FIG. 6).

To facilitate support of teeth and/or a matrix band, the height H of the legs may be in the range of 1-2.5 mm, such as in the range of 1.3-2.3 mm.

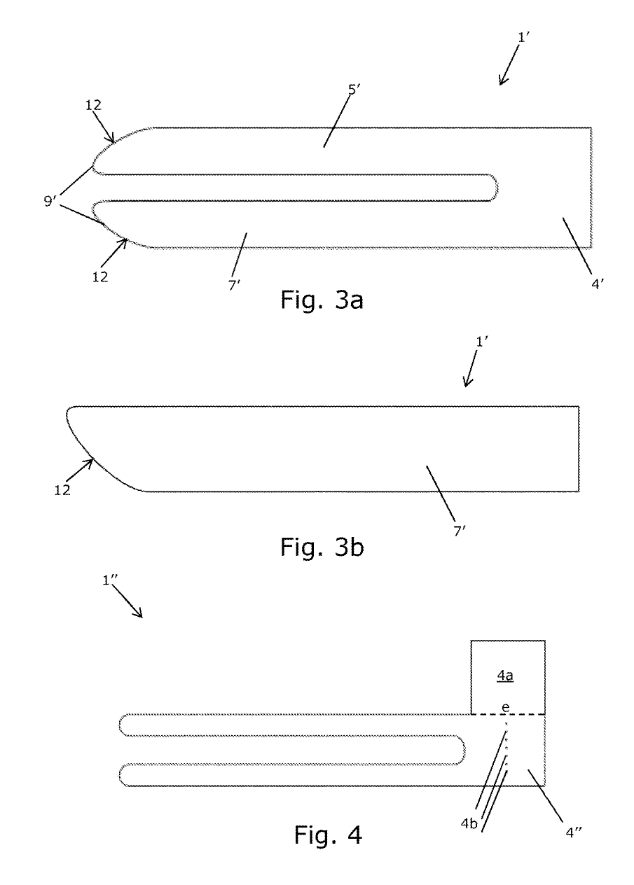

FIG. 3a illustrates an alternative embodiment of a dental tool 1′ seen form above, and FIG. 3b illustrates a side-view hereof. To reduce the risk of damaging tissue during insertion of the dental tool 1′, the height of the legs 5′, 7′ is smaller closer to the end 9′, than the height closer to the base 4′. To reduce the risk even further, lower edge of the legs 5′, 7′ may comprise rounded edges 12.

FIG. 4 illustrates an alternative embodiment of a dental tool 1″, in which the base 4″ comprises a support plate 4a adapted to be bended along an edge (indicated by the dotted line e) of the base 4″ to form a triangular shaped base, i.e. a base forming a substantially closed triangular shape in a cross-section perpendicular to the oblong direction. The support plate 4a extends in a direction perpendicular to the centre plane along an edge e of the base 4″. When the support plate is bended along this edge, the V-shaped base and the support plate may form a substantially triangular shaped element, thereby increasing stability of the base 4″.

The base 4″ further comprises a plurality of handling openings 4b adapted to receive a handling tool to facilitate positioning and/or removal of the dental tool between/from two adjacent teeth. The handling tool may as an example be a traditional dental instrument, such as tweezers.

FIG. 5a illustrates a 3D view of the dental tool 1′ from which the substantially triangular shape of the tool 1′ can be seen.

FIG. 5b illustrates a 3D view of the dental tool 1″. The support plate 4a is bended along the edge e of the base 4″ to form a triangular shaped base. This embodiment comprises two handling opening 4b.

FIG. 6 illustrates an embodiment of a dental tool 1 inserted between two adjacent teeth 2, 3. The first leg 5 is positioned in a first gum pocket 6 and is abutting a first one 2 of the two adjacent teeth and the second leg 7 is positioned in the second gum pocket 8 and is abutting the second one 3 of the two adjacent teeth. The roots 13 of the teeth extend into the bone material 14 and are fastened to the bone material 14 by elastic fibril tissue 15 extending into the upper gum tissue 11. Thus, the gum pockets 6, 8 are positioned between the upper gum tissue 11 and the tooth surfaces 16, 17.

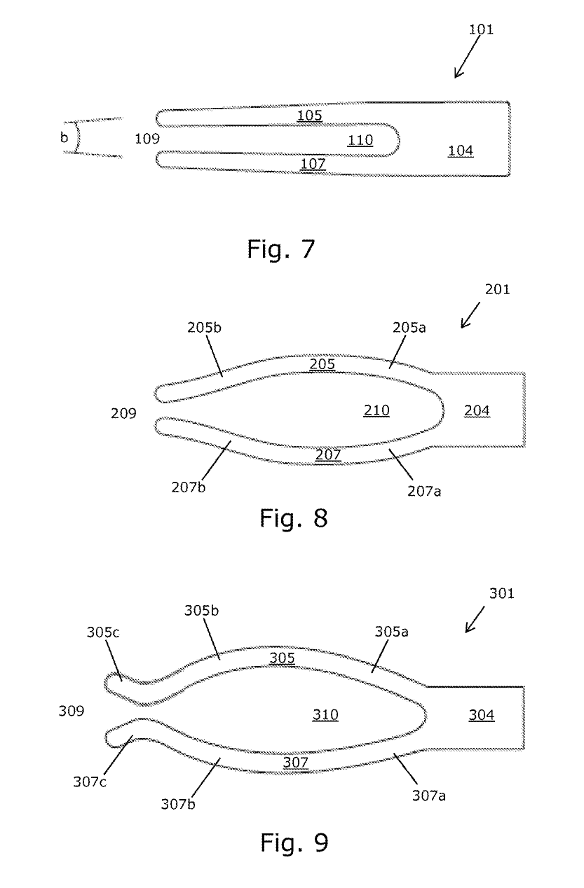

FIGS. 7-9 illustrate three different embodiments of a dental tool 101, 201, 301 seen from above. The dental tool 101 comprises a base 104, a first leg 105 for placement in a first gum pocket and for abutting a first one of two adjacent teeth and a second leg 107 for placement in a second gum pocket and for abutting a second one of two adjacent teeth. The legs 105, 107 are elongated and extend from the base 104 in an oblong direction towards an end 109.

The legs 105, 107 are separated with an interspace 110 between them for accommodating gum tissue. The legs 105, 107 are straight and extend towards each other, so that the size of interspace 110 at the end 109 is smaller than the size of the interspace towards the base 104. The angle between the legs 105, 107 is indicated by b.

The dental tool 201 comprises a base 204, a first leg 205 for placement in a first gum pocket and for abutting a first one of two adjacent teeth and a second leg 207 for placement in a second gum pocket and for abutting a second one of two adjacent teeth. The legs 205, 207 are elongated and extend from the base 204 in an oblong direction towards an end 209. The legs 205, 207 are separated with an interspace 210 between them for accommodating gum tissue. The first and second legs 205, 207 comprise a first section 205a, 207a where the legs diverge, and a second section 205b, 207b where the legs converge, i.e. the distance between the legs changes along the length of legs 205, 207. In the transition between the first and second section, the size of the interspace 210 is the greatest.

The dental tool 301 is similar to the dental tool 201. It comprises a base 304, a first leg 305, and a second leg 307. The first and second legs 305, 307 comprise a first section 305a, 307a where the legs diverge, and a second section 305b, 307b where the legs converge. Furthermore, the first and second legs 305, 307 comprise a third section 305c, 307c where the legs diverge, the third section 305c, 307c being positioned opposite to the base at the end 309.

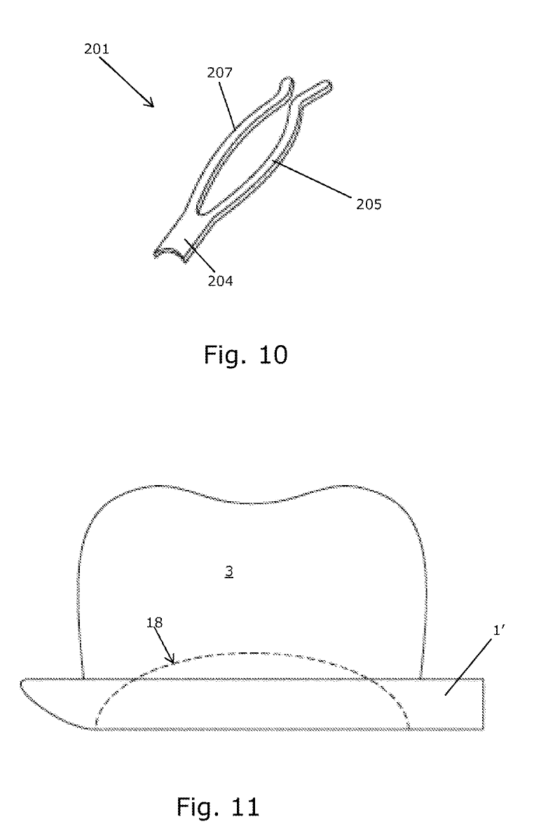

FIG. 10 illustrates a 3D view of the dental tool 201 of FIG. 8 from which the substantially triangular shape of the tool 201 can be seen.

FIG. 11 illustrates a side-view of a dental tool 1′ inserted between two adjacent teeth of which only one 3 is shown. As illustrated, the first and second legs may be inserted so deeply into the gum pockets (not shown), that the gum tissue 11 extends above the dental tool 1′ through the interspace. The top of the gum tissue 11 is illustrated by the dotted line 18.

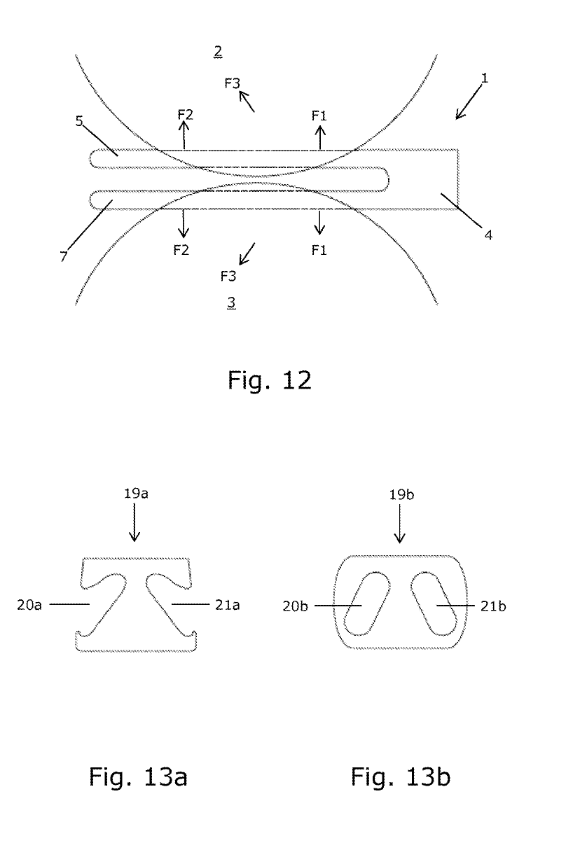

FIG. 12 illustrates a top-view of a dental tool 1 inserted between two adjacent teeth 2, 3. As the spring force exerted on the teeth is dependent on the distance from the base 4, the spring force F1 is larger than the spring force F2. This leads to a resulting spring force which is not perpendicular to the centre line CC (see FIG. 1). This oblique resulting spring force F3 against the teeth 2, 3 is a common problem with prior art wedges. This problem may be solved by the application of a locking member as illustrated in FIGS. 13a and 13b.

FIGS. 13a and 13b illustrates two different embodiments of a locking member 19a, 19b. The locking member 19 is adapted to lock the first and second legs relative to each other to ensure a predetermined distance between the legs.

The locking member 19 comprises a first cavity 20 to receive the first leg and a second cavity 21 to receive the second leg. In the embodiment illustrated in FIG. 13a, the cavities 20a, 21a are indentations, each having an opening in each of the sides of the locking member, through which openings the leg can be inserted. In the embodiment illustrated in FIG. 13b, the cavities 20b, 21b are through holes, through which holes the legs can be inserted after positioning of the dental tool. When the legs are positioned in the locking member 19, they are locked relative to each other thereby ensuring a predetermined distance between them.

Furthermore, the spring force exerted by the legs may be increased as the distance between the first and second cavities 20, 21 is larger than the distance between the first and second legs, whereby the legs are pressed away from each other to increase the force. This may further compensate for the oblique resulting spring force F3 illustrated in FIG. 12.

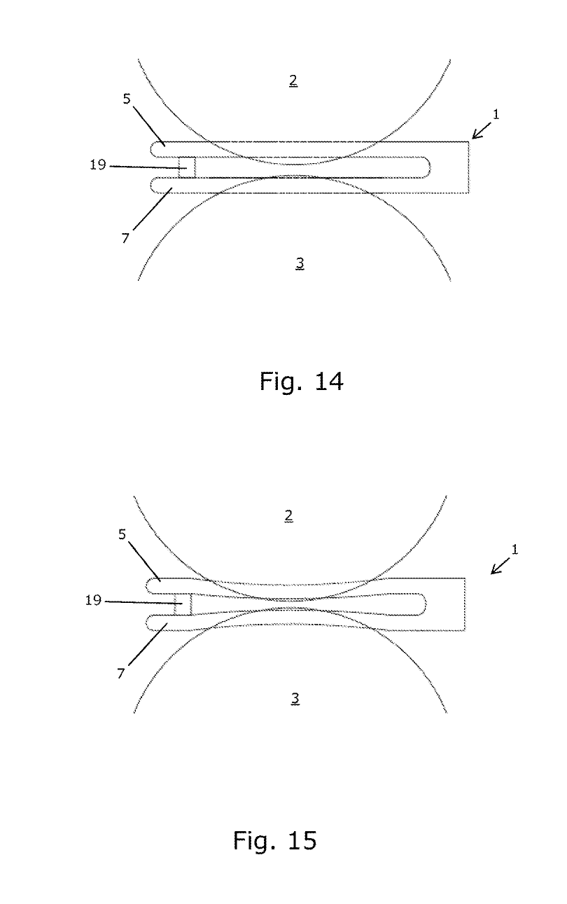

FIGS. 14 and 15 illustrate the application of a locking member 19 when the dental tool 1 is positioned between two adjacent teeth 2, 3. In FIG. 15, the legs 5, 7 are bended due to the limited space between the teeth.

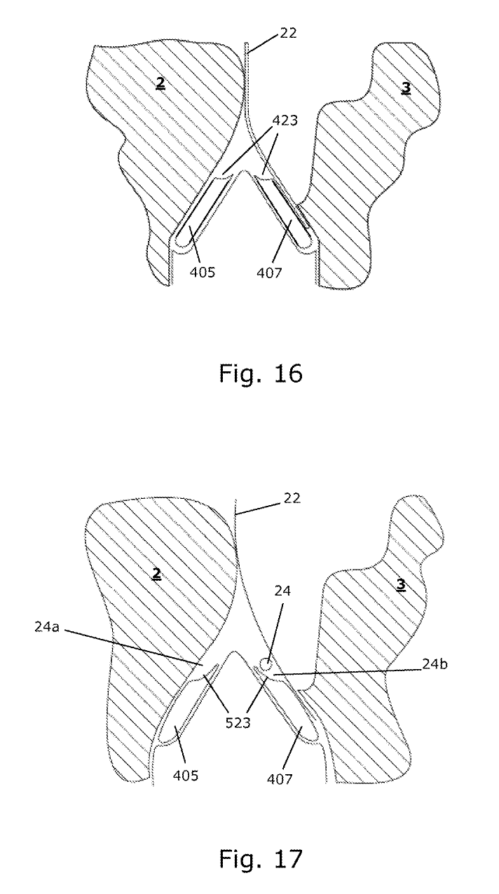

FIG. 16 illustrates a cross-sectional view of a dental tool 401 inserted between two adjacent teeth together with a matrix band 22. The dental tool 401 presses the matrix band towards the tooth 3 to the restored.

The thickness of the legs 405 and 407 is non-uniform, so that the thickness at the upper ends are decreased compared to the thickness of the legs at the lower end hereof. Each of the legs 405, 407 comprises a side section 423 along the length of the legs in which side section the thickness tapers down towards the edge of the leg.

FIG. 17 illustrates a dental tool 501 similar to the dental tool of FIG. 16. However, the side section 523 in which the thickness tapers down is larger in this embodiment thereby providing a space between the legs 505, 507 and the teeth 2, 3, respectively. A dental thread 24 is arranged in the space 24b for absorption of tissue liquid and/or blood.

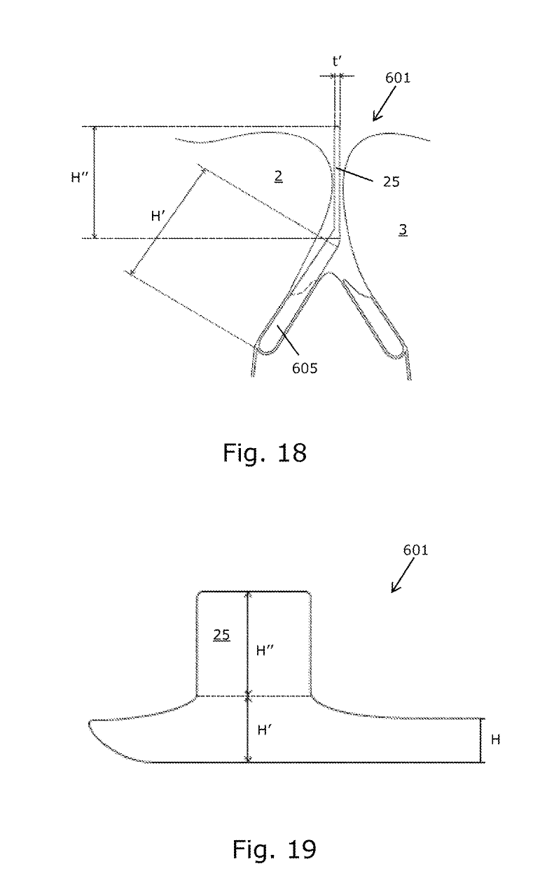

FIG. 18 illustrates a cross-sectional view through a dental tool 601 (see FIG. 1 for a side-view) inserted between two adjacent teeth 2, 3. The dental tool 601 comprises a separation member 25 attached to the first leg 605. This separation member 25 may replace a matrix band.

The thickness t′ of the separation member 25 may correspond to the thickness of the leg 605, or it may have a thickness being smaller. The effective height H′ of the leg 605 at the position at which the separation member is attached is larger than the height of the legs at other positions, as the leg 605 has to be extended to allow the separation member to extend upwardly between the teeth 2, 3. The height H″ of the separation member should be sufficient to extend above the teeth 2, 3 to provide sufficient support during the restoration process.

1. A dental tool for insertion between two adjacent teeth to provide a-traumatic separation of adjacent teeth of a human being, the tool comprising a base, a first leg for placement in a first gum pocket and for abutting a first one of the two adjacent teeth and a second leg for placement in a second gum pocket and for abutting a second one of the two adjacent teeth, the first and second legs being elongated and extending from the base in an oblong direction towards an end, the legs having a height in the range of 1-2.5 mm, and a length in the range of 5-10 mm in the oblong direction and being separated with an interspace between them for accommodating gum tissue, wherein the base connects the legs to each other and the end is a free end with no contact between the legs, and wherein the first and second legs comprise a first section where the legs diverge, and a second section where the legs converge, the first section being positioned adjacent to the base.

2. A dental tool according to claim 1, wherein the legs are longer than the base in the oblong direction.

3. A dental tool according to claim 1, wherein the first and second legs extend substantially symmetrically around a centre plane positioned centrally between the legs and extending in the oblong direction.

4. A dental tool according to claim 1, wherein the first and second legs are elastically deformable to enable deformation hereof in a direction transverse to the oblong direction thereby providing a spring force when deformed during insertion between two adjacent teeth.

5. A dental tool according to claim 1, wherein the first and second legs are mutually inclined, and the base is V-shaped.

6. A dental tool according to claim 1, wherein the first leg and the second legs extend substantially parallel.

7. A dental tool according to claim 1, wherein at least one of the first and second sections is arc shaped.

8. A dental tool according to claim 1, wherein the first and second legs comprise a third section where the legs diverge, the third section being positioned opposite to the base.

9. A dental tool according to claim 8, wherein the third section is arc shaped.

10. A dental tool according to claim 1, wherein the thickness of the first and second leg in a cross-section perpendicular to the oblong direction is non-uniform.

11. A dental tool according to claim 1, wherein the base comprises a support plate adapted to be bended along an edge of the base to form a triangular shaped base.

12. A dental tool according to claim 1, wherein the base comprises at least one handling opening adapted to receive a handling tool to facilitate positioning of the dental tool between two adjacent teeth.

13. A dental tool according to claim 12, wherein the at least one handling opening is a through hole.

14. A dental tool according to claim 1, further comprise a locking member adapted to lock the first and second legs relative to each other to ensure a predetermined distance between the legs, the locking member comprising a first cavity to receive the first leg and a second cavity to receive the second leg.

15. A dental tool according to claim 14, wherein the distance between the first and second cavities is larger than the distance between the first and second legs.

16. A dental tool according to claim 3, further comprising a separation member adapted to separate two adjacent teeth, the separation member being attached to one of the first and second legs and extending toward substantially along the centre plane.

17. A dental tool according to claim 1, wherein the tool is made in one piece.

18. A dental tool according to claim 1, wherein the tool is adapted to be separated in at least two separate elements.

19. A method for providing a-traumatic separation of two adjacent teeth of a human being during dental restoration, the method comprising the steps of:
providing a dental tool according to claim 1;
inserting the first leg in a first gum pocket so that it abuts a first one of two adjacent teeth; and
inserting the second leg in a second gum pocket so that it abuts a second one of two adjacent teeth, such that gum tissue becomes located in the interspace between the legs.
